(19) United States
(12) Patent Application Publication
(10) Pub. No.: US 2025/0111167 A1
(43) Pub. Date: Apr. 3, 2025

(54) DYNAMICALLY DETERMINED LANGUAGE MODEL SKILLS FOR RESPONDING TO A PROMPT

(71) Applicant: MICROSOFT TECHNOLOGY LICENSING, LLC, Redmond, WA (US)

(72) Inventors: Craig Thomas MCINTYRE, Kirkland, WA (US); Bradley Scott STEVENSON, London (GB); Andrew Paul MCGOVERN, Kirkland, WA (US); Adam Douglas TROY, Bothell, WA (US); Anand Sharad UNAWANE, Hyderabad (IN); Pankaj Vitthal AHER, Hyderabad (IN)

(21) Appl. No.: 18/527,117

(22) Filed: Dec. 1, 2023

(30) Foreign Application Priority Data
Oct. 3, 2023 (IN) 202311066113

(51) Int. Cl. G06F 40/40; G06F 16/383

(52) U.S. Cl. CPC G06F 40/40; G06F 16/383

(57) ABSTRACT

Various embodiments of the technology described herein dynamically determine at least one target LM skill to use to generate an output for an initial prompt without the need for the target LM skill to be included in the original prompt. Embodiments of the technology described herein perform this determination via an intermediate LM skill layer that implements an orchestration loop in a computationally efficient manner that reduces effects of hallucination by identifying one or more target LM skills based on each task identified in the initial prompt. Embodiments of the intermediate LM skill layer are separate from the user device and the LLM. For example, the intermediate LM skill layer is positioned between an LLM abstraction layer and an application layer by which a user can interface with the intermediate LM skill layer.

### CROSS-REFERENCE TO RELATED APPLICATION

This application claim the benefit of India Provisional Application No. 202311066113, filed on Oct. 3, 2023 and entitled “DYNAMICALLY DETERMINED LANGUAGE MODEL SKILLS FOR RESPONDING TO A PROMPT,” the entire contents of which are hereby incorporated by reference in their entirety.

### BACKGROUND

Computational linguistics, also known as Natural Language Processing (NLP), is a computer-based technique to understand, learn, and/or generate natural human language content. Recent advances in NLP technologies use sophisticated language models to derive a rich understanding of natural language. For example, some language models: engage in preprocessing pipelines via Part-of-Speech (POS) tagging (with tags such as noun, verb, and preposition); tokenize and parse sentences into their grammatical structures; and perform lemmatization, stemming, and the like for syntactic, semantic, or sentiment analysis.

Natural Language Generation (NLG) is one of the crucial yet challenging sub-fields of NLP. NLG techniques are used by certain language models, such as large language models (LLMs), in many downstream tasks such as text summarization, dialogue generation, generative question answering (GQA), data-to-text generation, and machine translation. However, these models are prone to certain issues. First, certain language models, such as LLMs, utilize a high volume of computational resources, making servicing various user prompts a computationally expensive endeavor. User prompts with additional tokens cause the computational resource utilization to increase. Second, certain language models are prone to “hallucination,” which refers to the generation of text that is nonsensical, unfaithful to the provided source input, or is otherwise incorrect. Hallucination is concerning because it hinders model performance, such as accuracy, especially when the desired output is complicated or includes a multimodal output, including text, graphics, or visual content. One way to address hallucinations and improve accuracy is through precise “prompt engineering,” whereby text is manually structured to be better understood or interpreted by the language model. However, a prompt input space is limited, reducing the overall capabilities to address hallucination and improve LLM accuracy through precise manual prompt engineering.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein dynamically determine at least one target language model (LM) skill to use to generate an output (also referred to herein in some examples as a “response,” “user response,” or “output”) to an initial prompt without the need for the target LM skill to be included in the original prompt. Embodiments of the technology described herein perform this determination via an intermediate LM skill layer that implements an orchestration loop in a computationally efficient manner that reduces effects of hallucination by identifying one or more target LM skills based on each task identified in the initial prompt. Embodiments of the intermediate LM skill layer are separate from the user device and the LLM. For example, the intermediate LM skill layer is positioned between an LLM abstraction layer and an application layer by which a user interfaces with the intermediate LM skill layer. Moreover, embodiments disclosed herein support on-demand control of the orchestration loop. In one example, the at least one target LM skill is determined using a higher number of orchestration loops during times with lower user activity and less computational resource consumption, thereby reducing impact to other services or technologies.

Whereas certain existing technologies allow for the manual inclusion of LM skills into prompts, such an approach increases computational burdens associated with a higher token size of the prompt, reduces response accuracy since the manually included LM skill may be unrelated to the desired response and produce hallucinations, and fails to allow scalability since only a limited number of LM skills can be input into the prompt given the prompt input space limitations.

The present disclosure provides one or more technical solutions that have technical effects in light of various technical problems. For example, particular embodiments have the technical effect of improved accuracy relative to existing models by implementing the technical solution of determining at least one target LM skill for use based on a task extracted from an initial prompt to more accurately generate a response, which existing language models do not do. Further, particular embodiments have the technical effect of reducing computational resource consumption by not requiring that the target LM skill be included as part of the initial prompt. Additionally, certain embodiments have the technical effect of increasing scalability, allowing computing systems to accommodate dozens, hundreds, thousands, or even millions of LM skills, an endeavor currently difficult, if not impossible, to accomplish by merely prompting in light of token size limitations associated with the prompt input.

### BRIEF DESCRIPTION OF THE DRAWINGS

The present invention is described in detail below with reference to the attached drawing figures, wherein:

FIG. 1 is a block diagram of an example operating environment suitable for implementations of the present disclosure;

FIG. 2 is a block diagram of an example system including an intermediate LM skill layer positioned between a user device and a language model, in accordance with an embodiment of the present disclosure;

FIG. 3 is a sequence diagram showing aspects of an intermediate LM skill layer operating in connection with a language model, in accordance with an embodiment of the present disclosure;

FIG. 4 is a flow diagram for implementing an intermediate LM skill layer and orchestration loop to generate a response to an initial prompt, in accordance with an embodiment of the present disclosure;

FIG. 5 is a flow diagram of an orchestration loop engine implemented by an intermediate LM skill layer in communication with a user device and an LLM, in accordance with an embodiment of the present disclosure;

FIG. 6 is a block diagram of a language model that uses particular inputs to make particular predictions, in accordance with an embodiment of the present disclosure;

FIG. 7 depicts a flow diagram of a method for transmitting an Application Programming Interface (API) call causing execution of the API call against the API of at least one target LM skill, in accordance with an embodiment of the present disclosure;

FIG. 8 depicts a flow diagram of a method for generating an API call associated with at least one target LM skill and comprising an API parameter input into an API of the at least one target LM skill based on a first task and a second task associated with an initial prompt, in accordance with an embodiment of the present disclosure;

FIG. 9 depicts a flow diagram of a method for executing an API call to generate at least a portion of a response to an initial prompt, in accordance with an embodiment of the present disclosure;

FIG. 10 is a block diagram of an example computing environment suitable for use in implementing an embodiment of the present disclosure; and

FIG. 11 is a block diagram of an example computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

Various embodiments discussed herein are directed to determining a language model (LM) skill for use to improve a language model (LM) response to an initial prompt from a user without directly passing the initial prompt to the LM. The LM skill can be dynamically determined for different scenarios of a user trying to interact with an LM. For example, LM skills are dynamically determined based on a user input used as the initial prompt and context associated with the user input. In this manner, an LM skill is identified and used without the user having to include the LM skill in the prompt. In one example, an “LM skill” refers to a data structure that includes a description of a software interface and the software interface itself. The software interface, such as an Application Programming Interface (API), generally provides a user and an LM, such as a large language model (LLM) or the user device, access to a corresponding software application, including the data and functionality of the corresponding software application. In one embodiment, the software application includes external data associated with an external data source.

In general, the capabilities of LLMs are limited by data contained within the training dataset of the LLM. However, purely relying on data contained in a training data set makes certain LLMs susceptible to hallucinations. One way to address these hallucinations is by guiding an LLM to a target output by precise engineering prompting, whereby text used as a prompt for the LLM is manually structured to be better understood or interpreted by the LLM. However, a prompt input space has a token size limit, reducing the overall capabilities to address hallucination and improve LLM accuracy through precise manual prompt engineering. Moreover, precise engineering prompting is a challenging endeavor because including too much information in the prompt (and in turn, including too many tokens) can cause the model to hallucinate while expending a large amount of computational resources.

More recently, sources external to the LLM have been utilized to expand the capabilities of LLM. For example, an LLM can communicate with these external sources via an API of an LM skill. Typically, to communicate with these external sources, the LLM is guided to use a particular LM skill via a prompt that includes the API of the LM skill and corresponding API input parameters. The prompt is generally a manual user input, which would require a user using LM skills to keep abreast of API developments and be sophisticated enough to manually input appropriate API parameters. Even then, users may choose an incorrect API, which causes the LLM to produce inadequate outputs and to hallucinate further. Additionally and as previously discussed, the prompt input space is limited in size, limiting the overall capacity for LM skills to be manually added to the prompt input space. Moreover, the addition of LM skills (and corresponding API input parameters) to the prompt input space increases computational resource consumption and further leads to hallucination issues as the model is given more “freedom” to expand beyond its training parameters and utilize information associated with the LM skill.

To reduce the effects of hallucination resulting from accessing many LM skills, certain LLMs currently limit the number of LM skills that can be included in the prompt. For example, certain LLMs limit the implementation of LM skills in a prompt to one, two, or three LM skills. Accordingly, to the extent LM skills can be used by certain LLMs to access external sources, the use of the LM skills is limited to using less than a handful of “static” LM skills manually input in the original prompt. Thus, certain existing approaches reduce the range of capabilities that LLMs can achieve with LM skills, require users to keep abreast of API developments, and limit the ability for LLMs to scale operations across dozens, hundreds, thousands, or even millions of LM skills.

With this in mind, embodiments discussed herein provide a technical solution to the deficiencies and limitations of existing technologies associated with LM skills. In one embodiment, an intermediate LLM interface layer separate from the user device and the LLM is employed to dynamically select at least one target LM skill without the need for including the LM skill in the original prompt. In one embodiment, the intermediate LM skill layer is positioned between an LLM abstraction layer and an application layer by which a user can interface with the intermediate LM skill layer. In one embodiment, the intermediate LM skill layer determines at least one skill to respond to an initial prompt based on a user input forming the initial prompt and context associated with the prompt or user input. Determination of the at least one skill can be iteratively performed for each task extracted based on the input, as discussed herein.

In more detail, at least one target LM skill is determined based on a task extracted from an input that includes (1) a prompt from the user device and (2) contextual data associated with the prompt received from the user device. As used herein, a “target LM skill” refers to the LM skill(s) of the candidate LM skills that is ultimately used by the system to respond to the initial prompt. In one example, the intermediate layer translates the prompt into one or more updated prompts that are sent to the LLM for processing. To help illustrate, suppose a user submits an initial prompt: “find all issues pending my approval, summarize their context, and provide recommendations for which I should approve in a bulleted list.” In this example, the intermediate LM skill layer intercepts this initial prompt before it is sent to the LLM, and the intermediate LM skill layer determines that three intents are contained in this initial prompt. For the first intent (in this example, “find all issues pending my approval”), the intermediate LM skill layer determines a first task, for example, “search the user's catalog for ‘issues pending my approval.’” In this example, this first task is communicated to an LLM as a first communication for which a response from the LLM is received by the intermediate LM skill layer. For example, the LLM returns an output associated with this first task, which in this example includes a list of issues pending approval.

For each of the tasks, embodiments discussed herein include performing a semantic search for a plurality of candidate LM skills. In one example, a “semantic search” refers to a search technique that extends traditional keyword-based searches to understand the meaning and context of the words used in a query. Instead of simply matching search terms, an example semantic search aims to comprehend the intent behind a user's query and deliver more relevant search results. For example, a semantic search relies on natural language processing (NLP) and artificial intelligence (AI) implemented by an LLM to analyze the semantics, relationships, and context of words and phrases in documents or web pages. This allows semantic search engines to provide more accurate and contextually relevant search results, even when the exact keywords may not be present in the documents.

In one embodiment, the intermediate LM skill layer performs a search (for example, a semantic search) for the plurality of candidate LM skills against one or more external databases. The plurality of candidate LM skills can each include an API, an API description, and an API specification document defining the API input parameters and other information associated with the API. Continuing the example above, after the intermediate LM skill layer receives the output associated with the first task, the intermediate LM skill layer performs a semantic search for a plurality of candidate LM skills associated with the output received from the LLM and associated with the first task.

After receiving the plurality of candidate LM skills, in one example, the intermediate LM skill layer generates a second communication for the LLM prompting the LLM to “choose one or more of the candidate LM skills based on [[task]], [[user input]], and [[context]],” whereby [[task]] includes alphanumeric characters indicative of a description of the task, [[user input]] includes alphanumeric characters indicative of at least a portion of the initial prompt, and [[context]] includes alphanumeric characters indicative of a description of context relevant to the user and the initial prompt. In response, the intermediate LM skill layer receives a second output from the LLM that is indicative of at least one target LM skill appropriate for the task. Continuing the example above, suppose that the plurality candidate LM skills included a first LM skill associated with MICROSOFT® Teams and a second LM skill associated with ClickUp®. After the second communication from the intermediate LM skill layer, in this example, the LLM determines that the first LM skill associated with MICROSOFT® Teams is more appropriate based on the user's context, indicating that the user manages his tasks on MICROSOFT® Teams, not on ClickUp®. Thereafter, the intermediate LM skill layer receives, as the target LM skill, the first LM skill selected by the LLM. In one example, the LLM provides to the intermediate LM skill layer at least one target LM skill and the corresponding API specification, including the API description, the API, and the API parameter inputs.

At this point in this example, the intermediate LM skill layer receives at least one target LM skill associated with the first task. If one task was identified in the initial prompt, then in this example the aforementioned one target LM skill would be sufficient for rendering a response to the initial prompt. However, in this example, three tasks were identified based on the user input of the initial prompt and the corresponding context. To account for the other two tasks, in this example, the aforementioned operations described in association with the first task are performed based on the second task (in this example, “summarize their context”) and the third task (in this example, “provide recommendations for which I should approve in a bulleted list”). In some embodiments, the intermediate LM skill layer implements an orchestration loop allowing for the at least one target LM skill to be determined for any number of tasks, either serially or in parallel.

As used herein in one example, an “orchestration loop” refers to a repetitive or iterative process whereby the intermediate LM skill layer serves as a controller that manages and coordinates the execution of various operations or components in a distributed or complex system. In one example, the orchestration loop automates, streamlines, and improves the speed and accuracy of determining at least one target LM skill to use to respond to an initial prompt without limits on the number of LM skills that can be accessed based on various specific user inputs and corresponding context. In one example, the orchestration loop ensures that tasks are determined and executed in a specific order or according to predefined rules for efficient determination of one or more target LM skills based on the embodiments discussed herein.

In one example, the orchestration loop runs in the intermediate LM skill layer until occurrence of a termination event. Example termination events include performing a threshold number of iterations of the orchestration loop or determining that the at least one target LM skill satisfies a threshold level of relatedness to the tasks, user input of the initial prompt, and/or context.

Particular embodiments have the technical effect of improved accuracy relative to existing models. This is because various embodiments implement the technical solutions of determining at least one target LM skill for use to more accurately respond to an initial prompt. Language models often hallucinate due to inaccuracies in their training data sets. Cleaning up or continuously updating the training data sets to address this issue would be a near impossible endeavor. One significantly more computationally efficient alternative is employing at least one target LM skill that leverages external data made accessible via corresponding APIs. To the extent that current LLMs employ LM skills, these LM skills are manually added by the user to an initial prompt. Indeed, such additional tokens corresponding to the addition of LM skills (and corresponding API input parameters) to the prompt input space can increase computational resource consumption. Additionally, such additional tokens and can further lead to hallucination issues as the model is given more “freedom” to expand beyond its training parameters and utilize information associated with the LM skill, even though the LM skill may not actually be relevant to a particular task. Instead, the embodiments discussed herein determine at least one target LM skill based on each identified task, the user input used as the initial prompt, and related contextual information.

Certain embodiments have the technical effect of reduced computational resource consumption relative to existing models. As discussed above, certain existing LLMs allow an LM skill to be input as part of the initial prompt. However, computational resources consumed by the LM increase as the input size (for example, token size) increases. Therefore, certain existing technologies allowing LM skills to be input as part of the initial prompt cause the LLM to consume significantly more resources than an initial prompt that does not include the LM skill. However, certain existing technologies do not allow the LLM to access an external API without the API information included in the prompt. As discussed herein, certain embodiments discussed herein provide an intermediate LM skill layer that facilitates LLM access to LM skills without the initial prompt including the LM skill. In this manner, the LLM is not computationally burdened with having to process additional tokens from the initial prompt.

Additionally, certain embodiments have the technical effect of increasing scaling to accommodate dozens, hundreds, thousands, or even millions of LM skills. Indeed, given the current token size limitations associated with the input prompt space, users are currently limited by these token size limitations when they formulate a prompt or try to point an LLM to LM skills. To the extent that certain existing approaches allow an LLM to pull data from an external API, such action occurs based on API-related information included in the initial prompt. Certain LLMs limit the number of static LM skills that an LM model can employ to avoid hallucinations. Accordingly, certain existing models place guardrails to limit the scaling of LM skills to avoid hallucinations. Hallucinations are less of a concern using these embodiments since the identified target LM skills are task-specific to a user input and context, instead of manually input by a user as the initial prompt.

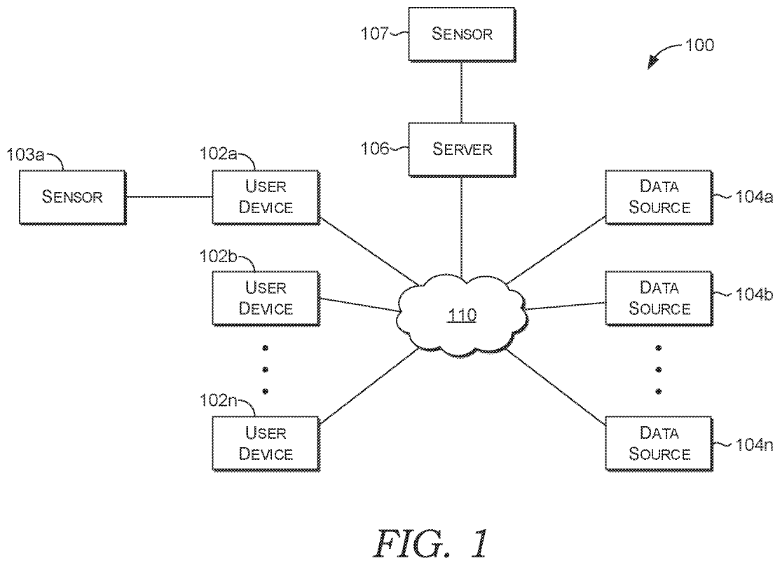

Turning now to FIG. 1, a block diagram is provided showing an example operating environment 100 in which some embodiments of the present disclosure can be employed. It should be understood that this and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

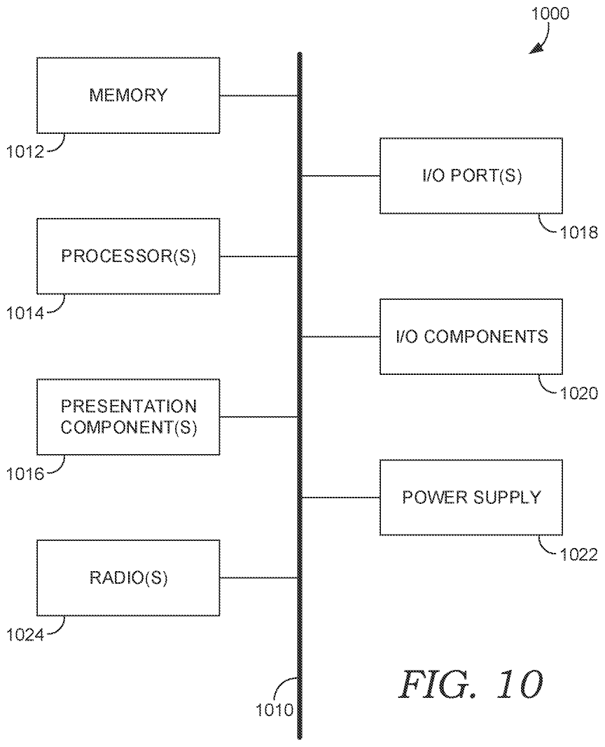

Among other components not shown, example operating environment 100 includes a number of user computing devices, such as user devices 102a and 102b through 102n; a number of data sources, such as data sources 104a and 104b through 104n; server 106; sensors 103a and 107; and network 110. It should be understood that operating environment 100 shown in FIG. 1 is an example of one suitable operating environment. Each of the components shown in FIG. 1 is implemented via any type of computing device, such as computing device 1000 illustrated in FIG. 10, for example. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

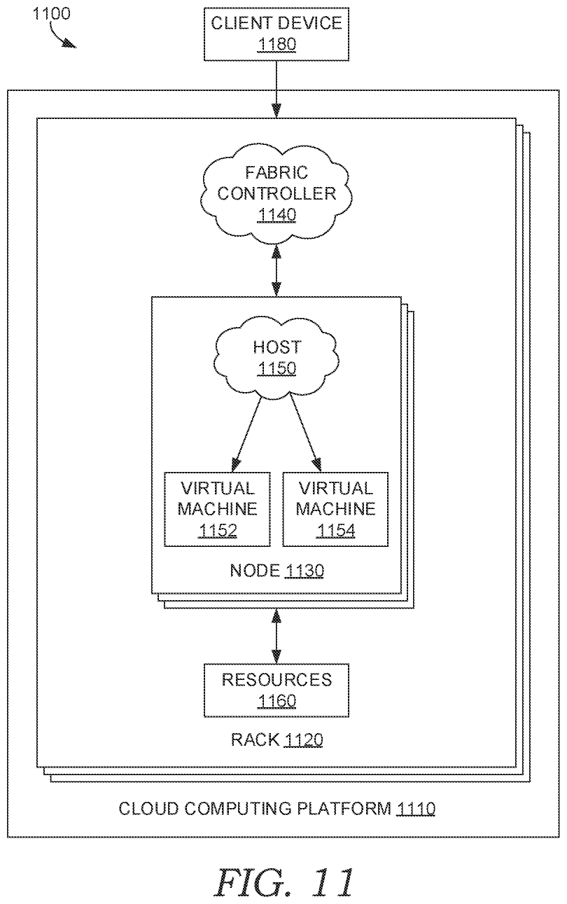

It should be understood that any number of user devices, servers, and data sources can be employed within operating environment 100 within the scope of the present disclosure. Each may comprise a single device or multiple devices cooperating in a distributed environment, such as the distributed computing device 1100 in FIG. 11. For instance, server 106 is provided via multiple devices arranged in a distributed environment that collectively provides the functionality described herein. Additionally, other components not shown may also be included within the distributed environment.

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. For example, user device 102a receives a prompt (for example, a language model prompt), and the server 106 runs the LLM to determine and generate a response to the prompt. This division of operating environment 100 is provided to illustrate one example of a suitable environment, and there is no requirement for each implementation that any combination of server 106 and user devices 102a and 102b through 102n remain as separate entities.

In some embodiments, user devices 102a and 102b through 102n comprise any type of computing device capable of use by a user. For example, in one embodiment, user devices 102a and 102b through 102n are the type of computing device 1000 described in relation to FIG. 10. By way of example and not limitation, a user device is embodied as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an MP3 player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

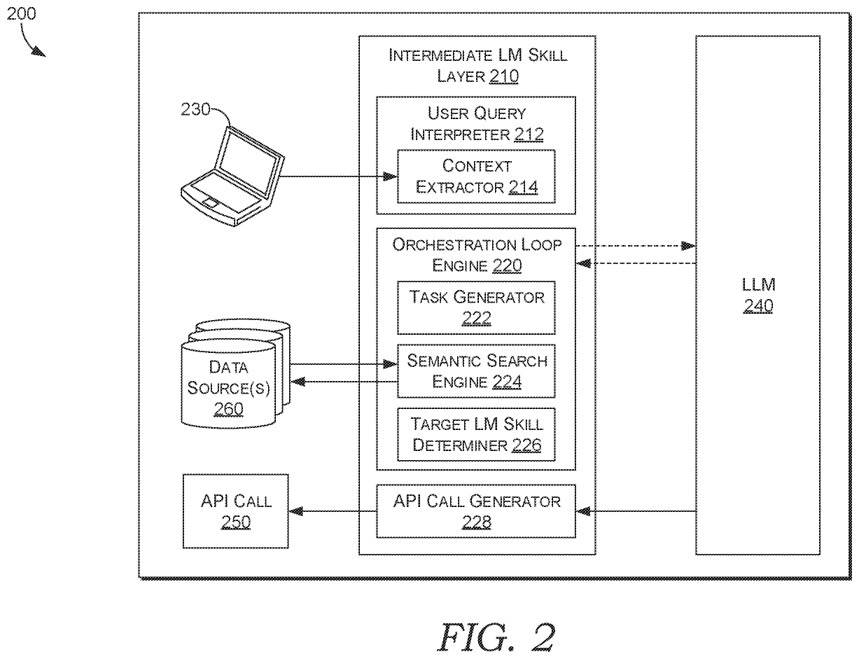

In some embodiments, data sources 104a and 104b through 104n comprise data sources and/or data systems, which are configured to make data available to any of the various constituents of operating environment 100 or system 200 described in connection to FIG. 2. For instance, one or more data sources 104a and 104b through 104n provide (or make available for accessing) an API response based on the API call. Certain data sources 104a and 104b through 104n are discrete from user devices 102a and 102b through 102n and server 106 or are incorporated and/or integrated into at least one of those components. In one embodiment, one or more of data sources 104a and 104b through 104n comprise one or more sensors, which are integrated into or associated with one or more of the user device(s) 102a and 102b through 102n or server 106. Examples of data made available by data sources 104a and 104b through 104n can include any suitable data made available to the intermediate LM skill layer 210 of FIG. 2.

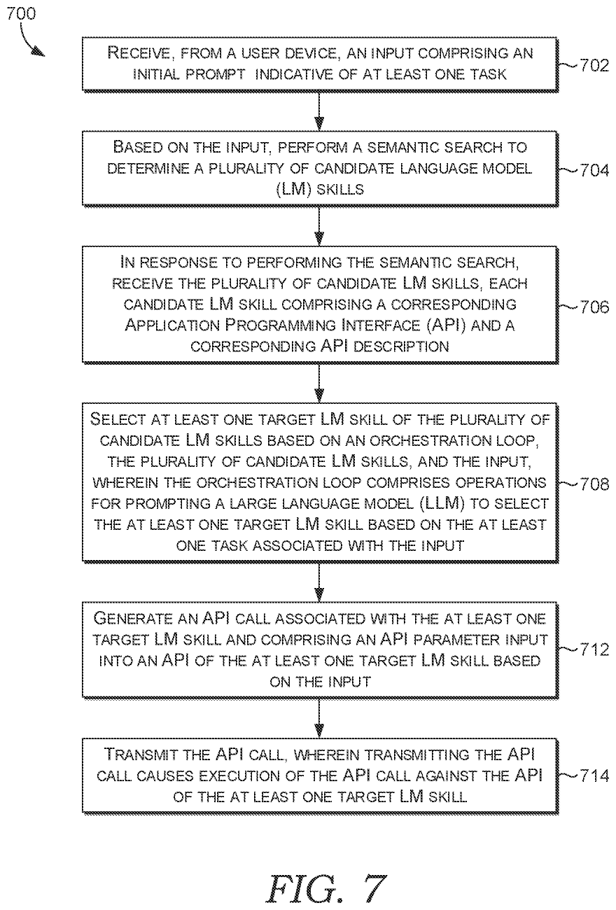

Operating environment 100 can be utilized to implement one or more of the components of system 200, as described in FIG. 2, to perform any suitable operations, such as receiving an initial prompt, determining tasks associated with the initial prompt, performing a semantic search for candidate LM skills, submitting a first communication prompting the LLM to describe a task, submitting a second communication prompting the LLM to select at least one target LM skill of the candidate LM skills, and executing an API call associated with the at least one target LM tool, and generating a user response to their initial prompt. Operating environment 100 can also be utilized for implementing aspects of methods 700, 800, and 900 in FIGS. 7, 8, and 9, respectively.

Referring now to FIG. 2, depicted is a block diagram of an example system 200 including an intermediate LM skill layer 210. The illustrated intermediate LM skill layer 210 includes a user query interpreter 212, including context extractor 214; an orchestration loop engine 220, including a task generator 222, a semantic search engine 224, and a target LM skill determiner 226; and an API call generator 228. In some embodiments, the intermediate LM skill layer 210 is positioned between a user device 230 and an LLM 240, in accordance with an embodiment of the present disclosure. Example system 200 also includes an API call 250 and data source 260.

With reference to the intermediate LM skill layer 210, the user query interpreter 212 is generally responsible for receiving an initial prompt that includes a user input intended for the LLM 240 and determining information, such as an intent and contextual information, associated with the initial prompt. In one example, a “prompt” as described herein includes one or more of: a request (for example, a question or instruction [for example, “write a poem]), target content, and one or more examples, as described herein. The prompt can be received as alphanumeric characters or as raw audio, to name a few non-limiting examples. In one example, “initial prompt” refers to the prompt directly received by the user, and which is unaltered by the intermediate LM skill layer 210. In one embodiment, the initial prompt is not communicated directly to the LLM 240 and is instead processed by the intermediate LM skill layer 210, as discussed herein.

In some embodiments, the user query interpreter 212 employs computing logic to infer an intent associated with an initial prompt. For example, the intent associated with the initial prompt is determined based on contextual information determined by the context extractor 214 of the user query interpreter 212. In some embodiments, context extractor 214 accesses user activity information and the initial prompt. Examples of user activity information include user location, app usage, online activity, searches, communications such as chat, call, or any suitable user-communication item data (including, for example, the duration of meeting, topics of the meeting, and speakers of the meeting), types of communication items with which a user interacts, usage duration, application data (for example, emails, meeting invites, messages, posts, user statuses, notifications, etc.), or nearly any other data related to user interactions with the user device or user activity via a user device. For example, a user's location is determined using GPS, indoor positioning (IPS), or similar communication functionalities of a user device associated with a user.

Embodiments of the context extractor 214 utilize the user activity information and the initial prompt to determine contextual information, also referred to herein in one example as a “context,” defining an intent associated with the initial prompt. As described herein, context (or context logic) may be used to determine an intent and corresponding tasks associated with the initial prompt, to perform a semantic search for candidate LM skills, to submit a first communication prompting the LLM to describe a task, to submit a second communication prompting the LLM to select at least one target LM skill of the candidate LM skills, to execute an API call associated with the at least one target LM tool, to generate a user response to their initial prompt, and/or to be consumed by a computing application, among other operations. By way of example, a context comprises information about a user's current activity, such as application usage, application consumption time, communication or interaction during consumption of an application or while interacting with an application, or other suitable interactions. For instance, a context can indicate types of user activity, such as a user performing a task, such as performing a work-related task, sending a message, or viewing content. Alternatively, or in addition, a user may explicitly provide a context, such as performing a query for a particular topic or content, which may be performed by engaging with a search tool of a productivity application or by submitting the initial prompt intended for the LLM 240. In one embodiment, a context includes information about an initial prompt or related applications and operating system (OS) features with which the user is interacting or accessing information about—as in where a user hovers their mouse over any suitable graphical user interface (GUI) elements.

Some embodiments of context extractor 214 determine context related to a user action or activity events, such as people entities identified in a user activity or related to the activity (for example, recipients of a message comprising content generated by the LLM), and utilize a named-entity extraction model or named-entity recognition model. In some embodiments, context extractor 214 comprises one or more applications or services that parse or analyze information detected via one or more user devices used by the user and/or cloud-based services associated with the user to identify, extract, or otherwise determine a user-related or user device-related context. Alternatively, or in addition, some embodiments of context extractor 214 monitor user activity information. In some embodiments, this information comprises features (sometimes referred to herein as “variables”) or other information regarding specific user-related activity and related contextual information. Some embodiments of context extractor 214 determine, from the monitored user activity data and the initial prompt, intent associated with the initial prompt based on the particular user, user device, or a plurality of users (such as a specific group of people, a group of people sharing a role within an organization, a student, a professor, or faculty), and/or user devices. In some embodiments, an intent determined by context extractor 214 is provided to other components of system 200 or stored in a user profile associated with a user.

Continuing with the intermediate LM skill layer 210, the orchestration loop engine 220 is generally responsible for communicating with the LLM to determine at least one target LM skill from a plurality of candidate LM skills. Certain embodiments of the intermediate LM skill layer 210 employ orchestration logic to determine a task from the intent (determined by the user query interpreter 212) to perform a semantic search for a plurality of candidate LM skills associated with the task and determine a target LM skill of a plurality of candidate LM skills, among other operations. In some embodiments, some of these operations are performed by the orchestration loop engine 220 for each task identified in the user query interpreter.

Continuing with the intermediate LM skill layer 210, the task generator 222 is generally responsible for determining a task based on the data determined by the user query interpreter 212. In some embodiments, the task generator 222 employs task determination logic to determine the task. In one embodiment, the task generator 222 receives data from the user query interpreter 212, such as the user input into the prompt, corresponding context, and an intent determined from the user input and the corresponding context. In some embodiments, the task generator determines a task based on certain semantics contained in the user input. For example, the subject-verb arrangement of the intent is translated into a task.

To help illustrate, suppose a user submits an initial prompt: “find all issues pending my approval, summarize their context, and provide recommendations for which I should approve in a bulleted list.” In this example, the user query interpreter 212 intercepts this initial prompt and determines that three intents are contained in this initial prompt. From these three intents, an example task generator 222 determines corresponding tasks. In one embodiment, the intents are determined from the verbs in the prompt, such as “find,” “summarize,” and “provide,” from this example. For the first intent (in this example, “find all issues pending my approval”), the task generator 222 determines a first task, for example, “search the user's catalog for ‘issues pending my approval;’” the task generator 222 determines a second task, for example, “summarize the content of the ‘issues pending my approval;’” and the task generator 222 determines a third task, for example, “generate a list of bullet points containing a recommendation of agenda items for me based on the ‘issues pending my approval.’” As illustrated by this example, embodiments of the task generator 222 translate the intent determined by the user query interpreter 212 into a task.

In some embodiments, the task generator 222 communicates the output from the user query interpreter 212 to the LLM and generates a target prompt to cause the LLM to determine the tasks. Using the previous example, the task generator 222 communicates the intents determined from the user input to the initial prompt to the LLM 240, and prompts the LLM to “generate tasks for [[intents]],” where [[intents]] corresponds to the three intents determined by the user. In one embodiment, this target prompt is communicated to the LLM 240 as a first command. In response to this first communication, the task generator 222 receives the output from the LLM that is indicative of the tasks associated with the intents. In this manner, the intermediate LM skill layer 210 can leverage functionality and power of the LLM 240 through precise prompt engineering based on the intent extracted by the user query interpreter to determine a task. After the task generator 222 determines the task or receives the task(s) from the LLM 240 in response to the aforementioned first command, embodiments of the task generator 222 transmits the task to the semantic search engine 224.

Continuing with the intermediate LM skill layer 210, the semantic search engine 224 is generally responsible for performing a search for a plurality of candidate LM skills based on a task. In one embodiment, the semantic search engine 224 is contained in the LLM 240. In one embodiment, the semantic search engine 224 determines the plurality of candidate LM skills specific to one task, the corresponding intent, and/or related contextual information. In one embodiment, the semantic search engine 224 generates a query against data sources 260 for a candidate LM skills determined suitable for a corresponding task received from task generator 222. As described herein in one example, a “semantic search” refers to a search technique that extends traditional keyword-based searches to understand the meaning and context of the words used in a query. Instead of simply matching search terms, an example semantic search aims to comprehend the intent behind a user's query and deliver more relevant search results. For example, a semantic search relies on natural language processing (NLP) and artificial intelligence (AI) implemented by an LLM to analyze the semantics, relationships, and context of words and phrases in documents or web pages.

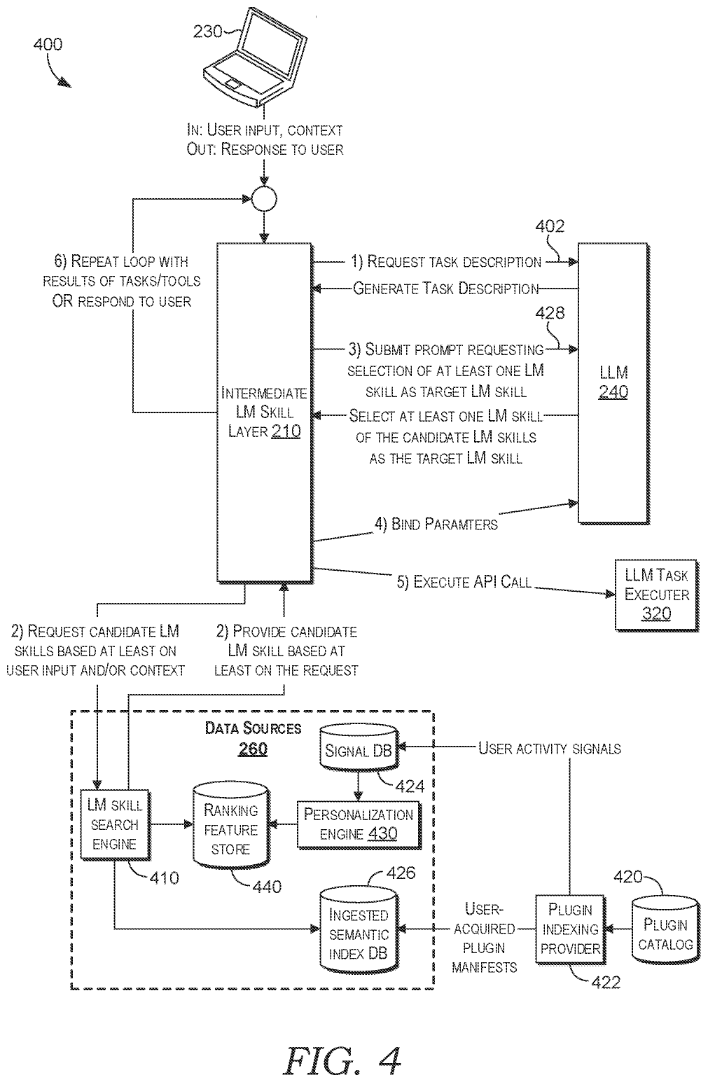

In one embodiment, the semantic search engine 224 performs a search (for example, a semantic search) for the plurality of candidate LM skills against one or more databases of the data sources 260, such as those illustrated in FIG. 4. Continuing the example above, for the first task “search the user's catalog for ‘issues pending my approval,’” the semantic search engine 224 identifies software applications, resources, and databases containing matters requiring “the user's approval.” In one embodiment, the software applications, resources, and databases containing this information are separate from the user device 230, the intermediate LM skill layer 210, and the LLM 240. For example, the information searched by the semantic search engine 224 is contained in the example data sources 260. In one example, the example data sources 260 store a catalog of LM skills, including two, four, five, dozens, hundreds, thousands, millions, or any number of LM skills.

Embodiments of the semantic search engine 224 perform a search to find related candidate LM skills within a semantic vector space to the task, for example, through the use of word embedding and vector representations of the task and query. In some embodiments, proximity of the task to another data structure (such as the candidate LM skills) is indicative of a level of relatedness. In some embodiments, the plurality of candidate LM skills are semantically similar to and near in the vector space to the task. For example, each word in a corpus (collection of text) is represented as a high-dimensional vector in a semantic vector space. These vectors can be created using techniques like Word2Vec, GloVe, Bidirectional Encoder Representations from Transformers (BERT), or any suitable technique. In one embodiment, documents, such as articles associated with LM skills, web pages associated with LM skills, or queries associated with LM skills, are also transformed into vectors by aggregating or averaging the word embeddings of the words within them, generating a vector representation of the document's semantic meaning. To find related results, embodiments of the semantic search engine 224 calculate the semantic similarity between the vector representation of the query associated with the task and the vector representations of LM skills in the corpus. Example similarity measures include cosine similarity or Euclidean distance. In some embodiments, the semantic search engine 224 utilizes a relevance threshold to filter out LM skills that are not sufficiently similar to the task, ensuring that those LM skills that satisfy the relevance threshold are surfaced as candidate LM skills. Certain embodiments of the semantic search engine 224 incorporate user feedback to improve results over time. For example, if a user utilizes certain LM skills at a high frequency, the system 200 may learn to give those types of LM skills higher relevance in future searches.

Continuing the example above, suppose that the plurality candidate LM skills include a first LM skill associated with MICROSOFT® Teams and a second LM skill associated with ClickUp® because both of these LM skills include information requiring “the user's approval,” as indicated by the first task. Based on the semantic search, embodiments of the semantic search engine 224 receive a plurality of candidate LM skills related to the first task. In one embodiment, the plurality of candidate LM skills are a subset of the total of LM skills accessible to the semantic search engine 224. The plurality of candidate LM skills can each include an API, an API description, and an API specification document defining the API input parameters and other information associated with the API.

Continuing with the intermediate LM skill layer 210, the target LM skill determiner 226 is generally responsible for determining which LM skill(s) of the plurality of candidate LM skills to include as part of the target LM skill that is used to respond to the initial prompt. In some embodiments, the target LM skill determiner 226 utilizes a target LM skill-determining logic to determine which LM skill(s) of the plurality of candidate LM skills to include as part of the target LM skill. In some embodiments, the target LM skill determiner 226 receives, from the semantic search engine 224, an indication of the candidate LM skills. In one embodiment, the target LM skill determiner 226 receives the candidate LM skills directly from the example data sources 260 in response to the semantic search performed by the semantic search engine.

After receiving the plurality of candidate LM skills, in one example, embodiments of the target LM skill determiner 226 leverage the functionality of the LLM 240 to select the target LM skill from the candidate LM skills. For example, the target LM skill determiner 226 generates a second communication for the LLM prompting the LLM to select at least one of the LM skills of the plurality of candidate LM skills as the target LM skill(s). In some embodiments, the second communication includes a prompt having information related to at least one of: the plurality of candidate LM skills (determined based on the semantic search engine 224), the task (determined by the task generator 222), the intent or content (extracted from the user query interpreter 212), or any other information generated or received by components of the system 200.

In one embodiment, the target LM skill determiner 226 generates the second communication for the LLM, prompting the LLM to “choose one or more of the candidate LM skills based on [[task]], [[user input]], and [[context]].” In this example, [[task]] includes alphanumeric characters indicative of a description of the task (determined by the task generator 222), [[user input]] includes alphanumeric characters indicative of at least a portion of the initial prompt (submitted via user device 230 and received via user query interpreter 212), and [[context]] includes alphanumeric characters indicative of a description of context relevant to the user and the initial prompt (as determined by user query interpreter 212). In response to the second communication for the LLM 240, embodiments of the target LM skill determiner 226 receive a second output from the LLM 240 that is indicative of at least one target LM skill appropriate for the task.

Continuing the example above, suppose that the plurality candidate LM skills included a first LM skill associated with MICROSOFT® Teams and a second LM skill associated with ClickUp®. After the second communication from the intermediate LM skill layer, in this example, the LLM 240 determines that the first LM skill associated with MICROSOFT® Teams is more appropriate based on the user's context indicating that the user manages his tasks on MICROSOFT® Teams, not on ClickUp®. Thereafter, the target LM skill determiner 226 receives, as the target LM skill, the first LM skill selected by the LLM 240. In one example, the LLM 240 provides to the target LM skill determiner 226 at least one target LM skill and the corresponding API specification, including the API description, the API, and the API parameter inputs.

At this point in this example, the intermediate LM skill layer 210 receives at least one target LM skill associated with the first task. In some embodiments, the intermediate LM skill layer 210 performs the aforementioned operations associated with the components of the orchestration loop engine 220 (for example, the task generator 222, the semantic search engine 224, and the target LM skill determiner 226) for each of the tasks determined by task generator 222. In this example, three tasks are identified based on the user input of the initial prompt and the corresponding context. To account for the other two tasks, in this example, the aforementioned operations described in association with the first task are performed for the second task (in this example, “summarize their context”) and the third task (in this example, “provide recommendations for which I should approve in a bulleted list”). In one embodiment, the aforementioned operations associated with the second task and/or the third task are performed in parallel to those associated with the first task to improve computational speed and response time. In some embodiments, the orchestration loop engine 220 implements the orchestration loop discussed herein either serially or in parallel based on computational resource availability, for example, associated with a user's account. For example, a premium user can receive preferential resource allocation over a user having a free, unpaid account. In this example, the orchestration loop engine 220 implements the orchestration loop in parallel for each task for the premium user for quicker response time. On the other hand, in this example, the orchestration loop engine 220 implements the orchestration loop in series for each task for the free, unpaid user, resulting in a slower response time based on computational resource management in favor of the premium user.

The API call generator 228 is generally responsible for generating an API call associated with the target LM skill. In some embodiments, the API call generator utilizing API logic to execute an API call associated with the target LM skill based on the tasks associated with the initial prompt. In some embodiments, the API call generator 228 generates an API call 250 against the target LM skill to retrieve data from databases, websites, or external services. For example, the API call generator 228 sends requests to specific API endpoints associated with the target LM skill to retrieve information in a structured format (for example, JavaScript Object Notation [JSON] or Extensible Markup Language [XML]) that would be responsive to the initial request. In this example, the API call 250 generated by the API call generator 228 causes the intermediate LM skill layer 210 or the LLM to receive the information in the structured format.

In some embodiments, the API call generator 228 can integrate the LM skill into a workflow associated with the user to automate operations for the user. For example, an LM skill associated with a social media platform can use APIs to schedule posts, gather analytics, and interact with social media platforms on behalf of users based on the API call 250. In this manner, the API call can extend the functionality afforded by the LLM 240 by integrating APIs of the LM skills with the LLM 240. In some embodiments, the API call generator 228 generates an API call 250 that is specific for the tasks analyzed by the orchestration loop engine 220, such that the API call 250 is for the specific initial prompt from the user.

Based on the API call 250 generated by API call generator 228, the LLM 240 or the intermediate LM skill layer 210 can received the API response and transform the data into a format that is consumable by the user. For example, continuing the example above where the initial prompt included a request for content in bullet form, the LLM 240 or the intermediate LM skill layer 210 receives the information included in the API response and restructures the information into the bullet format requested by the user. In this example, the bullet format includes a bulleted list of “recommendations pending the user's approval.”

In some embodiments, various components of system 200 communicates the LLM 240 or the intermediate LM skill layer 210 via one or more applications or services on a user device, across multiple user devices, or in the cloud, to coordinate presentation of a response to the initial prompt in a format requested by the user. In one embodiment, LLM 240 or the intermediate LM skill layer 210 manages the presentation of the response to the initial prompt based on the target LM skills across multiple user devices, such as a mobile device, laptop device, or virtual-reality (VR) headset, and so forth.

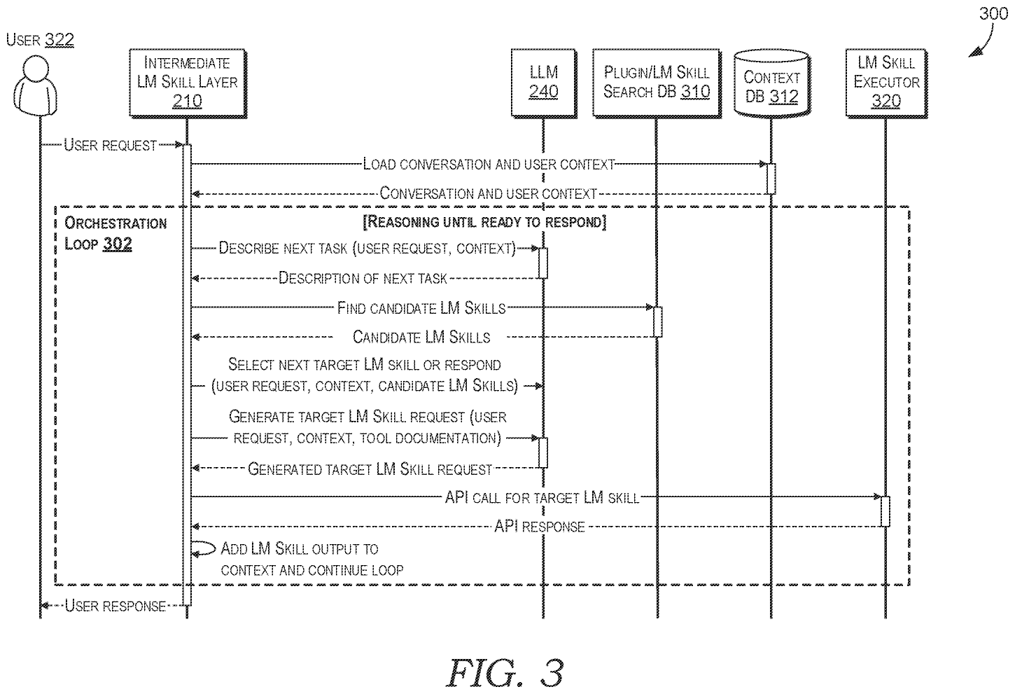

Turning to FIG. 3, depicted is a sequence diagram 300 including an intermediate LM skill layer 210 operating in connection with a language model 240 and other components, in accordance with an embodiment of the present disclosure. In some embodiments, the steps in the sequence diagram, such as implementation of the orchestration loop 302, are performed by certain embodiments illustrated in FIGS. 2, 4, 5, and 6, for example, to implement aspects of the flow diagrams of FIGS. 7, 8, and 9. In addition to including the intermediate LM skill layer 210 and the language model 240, the illustrated sequence diagram 300 includes an LM skill database 310, a context database 312, and an LM skill executor 320.

As illustrated by the sequence diagram 300, a user 322 submits an initial prompt based on a user request for information based on an LLM query. However, it should be understood that in some embodiments the initial prompt is automatically generated by a computing device, such as computing system 1000 of FIG. 10, without any intervention or user request from the user 322.

As illustrated, the intermediate LM skill layer 210 intercepts the initial prompt without directly communicating the initial prompt and the user request to the LLM. Instead, the intermediate LM skill layer 210 receives the initial prompt and accesses contextual information from context database 312. In some embodiments, the intermediate LM skill layer 210 implements aspects of the user query interpreter 212 (FIG. 2) to determine the contextual information and the intent. In some embodiments, the intermediate LM skill layer 210 receives contextual information from user databases, such as those illustrated in FIG. 4. Thereafter, embodiments of the intermediate LM skill layer 210 receive the contextual information related to the initial prompt. In some embodiments, the intermediate LM skill layer 210 continues to receive contextual information until determining that sufficient contextual information associated with the initial prompt has been provided.

Thereafter, embodiments of the intermediate LM skill layer 210 generate a first command (for example, a first prompt) prompting the LLM 240 to describe a task based on the initial prompt, the user request from the user 322, the contextual information from the context database 312, and/or an intent inferred from the contextual information. For example, the intermediate LM skill layer 210 generates a first command indicative of a prompt including a request for at least one task based on the initial prompt, the user request from the user 322, the contextual information from the context database 312, and/or an intent inferred from the contextual information. In some embodiments, the first command is generated based on the task generator 222 of FIG. 2. Based on the first command, embodiments of the LLM 240 communicate a first LLM response indicative of any number of tasks determined based on the first command. In this example, the intermediate LM skill layer 210 receives a description or indication of tasks identified by the LLM 240.

Continuing with the sequence diagram 300, after the intermediate LM skill layer 210 receives a description or indication of tasks identified by the LLM 240, the intermediate LM skill layer 210 performs a search, such as a semantic search, for candidate LM skills. In some embodiments, the search is performed based on the semantic search engine 224 of FIG. 2. In one embodiment, the search is performed against the LM skill database 310. In one embodiment, the LM skill database 310 stores a catalog of LM skills and corresponding information, such as corresponding API, API description, API specification sheets, or any other suitable information associated with the LM skills associated with LM skill database 310. Based on the search, the intermediate LM skill layer 210 receives an indication of the candidate LM skills associated with a particular task.

Continuing with the sequence diagram 300, after the intermediate LM skill layer 210 receives the candidate LM skills, the intermediate LM skill layer 210 generates a second command (for example, a second prompt) prompting the LLM 240 to select at least one LM skill of the plurality of candidate LM skills the target LM skill used to service an aspect of the initial prompt. In some embodiments, the selection of the target LM skill is performed based on the target LM skill determiner 226 of FIG. 2. In one embodiment, the target LM skill is determined based on the initial prompt, the user request, the contextual information received from context database 312, and/or the intent. In some embodiments, the target LM skill is task-specific, such that the LLM 240 determines the target LM skill based on the task. Based on the second command, embodiments of the LLM 240 communicate a second LLM response indicative of the target LM skill determined based on the second command. In this example, the intermediate LM skill layer 210 receives the target LM skill and corresponding API parameter inputs for generating an API call to the target LM skill. For example, the API parameter inputs are generated based on the task, the initial prompt, the user request, the contextual information received from context database 312, and/or the intent.

Thereafter, the intermediate LM skill layer 210 generates an API call executed against the LM skill executor 320. In one embodiment, the LM skill executor 320 corresponds to an endpoint associated with the target LM skills and is configured to return an API response based on execution of the API call. For example, based on the API call communicated by the intermediate LM skill layer 210, the LM skill executor generates an API response for the API of the target LM task. In one example, the API response is received by the intermediate LM skill layer 210 or the LLM 240, and then communicated to the user 322 as the response to their initial query. Indeed, in one embodiment, the response to the initial prompt is generated without the initial prompt being directly forwarded to the LLM 240, for example, despite the intention of the user that the initial prompt be forwarded to the LLM 240.

In some embodiments, the intermediate LM skill layer 210 implements the orchestration loop to determine, serially or in parallel, the API response for different target LM tools that are task-specific (for example, for the task determined by the task generator 222 of FIG. 2). In some embodiments, the orchestration loop is run until at least one of: a threshold quantity of loops is reached or until the at least one target LM skill has a threshold level of relatedness to the input. In some embodiments, the threshold level of relatedness is determined based on a semantic vector space, as discussed herein. For example, the semantic vector space associated with the tasks is compared against the descriptions of the at least one target LM skills. Embodiments of the orchestration loop run until a threshold level of relatedness between the semantics of the tasks and the target LM skills is achieved. Thereafter, the intermediate LM skill layer 210 provides a response based on the target LM skills. After the orchestration loop is run, embodiments of the sequence diagram 300 include communicating an aspect of the API responses to the user 322.

FIG. 4 is a schematic flow diagram 400 for implementing an intermediate LM skill layer 210 and orchestration loop to generate a response to an initial prompt, in accordance with an embodiment of the present disclosure. As illustrated, the user device 230 submits an input comprising a user input indicative of an initial prompt for an LLM 240. The illustrated intermediate LM skill layer 210 receives an input that includes the initial prompt and contextual information, as described herein. Based on the input, the illustrated intermediate LM skill layer 210 requests that the LLM generate an indication of a task based on the input. In one embodiment, the LLM 240 receives this request as a first input 402 (also referred to herein as a “first command,” in one embodiment). Thereafter, the illustrated intermediate LM skill layer 210 receives an indication of the task description generated by the LLM 240.

Additionally, the illustrated intermediate LM skill layer 210 requests candidate LM skills based on the task description, the input, the context, and/or the like. In some embodiments, the request includes performing a semantic search for the candidate LM skills. For example, the request for candidate LM skills is processed by an LM skill search engine 410 that searches data sources 260 for the candidate LM skills. In one embodiment, the data sources 260 correspond to the LM skill database 310 of FIG. 3.

As illustrated, a plugin catalog 420 that includes information related to the LM skills can push information associated with LM skills. Alternatively, the information associated with LM skills can be pulled from the plugin catalog 420. In some embodiments, the plugin indexing provider 422 indexes the information obtained from the plugin catalog 420 based on the respective LM skill such that information associated with the LM skill is indexed by the LM skill. However, it should be understood that the plugin indexing provider 422 can index the information associated with LM skills based on any suitable index, such as timestamps, sources, category of sources, users, groups, and so forth. For example, the plugin indexing provider 422 indexes the information associated with the LM skill based on user activity labels stored in signal database 424 or user-acquired plugin manifests stored in ingested semantic index database 426.

To further personalize determination of candidate LM skills, embodiments of signal database 424 store user activity labels (for example, binary labels such as positive or negative labels, or other non-binary labels) associated with the information for the LM skills from plugin catalog 420. For example, the labels can be manually generated based on user feedback or automatically generated based on a pattern of user activity. In this manner, the personalization engine 430 can receive the labels from the signal database 424 to generate a ranking feature score for each of the LM skills from the plugin catalog 420. Moreover, in one embodiment, the ingested semantic index database 426 stores an indication of whether the user has pre-installed a corresponding LM skill or related plugin. In this manner, the system 200 of FIG. 2 can give higher weight to an LM skill corresponding to a related LM skill or related plugin that has already been installed on a user's device or is in association with the user's account.

Based on the data accessed or contained in the illustrated data sources 260, the LM skills are ranked and their corresponding rankings stored in a ranking feature database 440. In one embodiment, the LM skill search engine 410 ranks the LM skills obtained from plugin catalog 420 based on the labels stored in the signal database 424 and/or the user-acquired plugin manifests stored in the ingested semantic index database 426.

Continuing with FIG. 4, the illustrated data sources 260 provide to the intermediate LM skill layer 210 the candidate LM skills, as discussed herein based on the request for candidate LM skills. Thereafter, the illustrated intermediate LM skill layer 210 generates a second command received by the LLM as a second input 428, prompting the LLM 240 to select at least one LM skill from the candidate LM skills and use it as the target LM skill. Based on the second command (for example, the second input 428) from the illustrated intermediate LM skill layer 210, embodiments of the LLM 240 select at least one LM skill of the candidate LM skills as the target LM skill. In some embodiments, the LLM 240 or the intermediate LM skill layer 210 determines API input parameters for the API of the target LM skill. In some embodiments, the illustrated intermediate LM skill layer 210 binds the API input parameters to the API of the target LM skill to execute an API call associated with the target LM skill.

These operations can be iteratively performed based on the orchestration loop disclosed herein. For example, these operations can be performed serially or in parallel for each task identified or extracted from the initial task. After an end event associated with the orchestration loop, in one example, the orchestration loop stops and the API calls associated with the tasks are executed and their contents are summarized, structured, and/or output to the user as a response to their initial prompt.

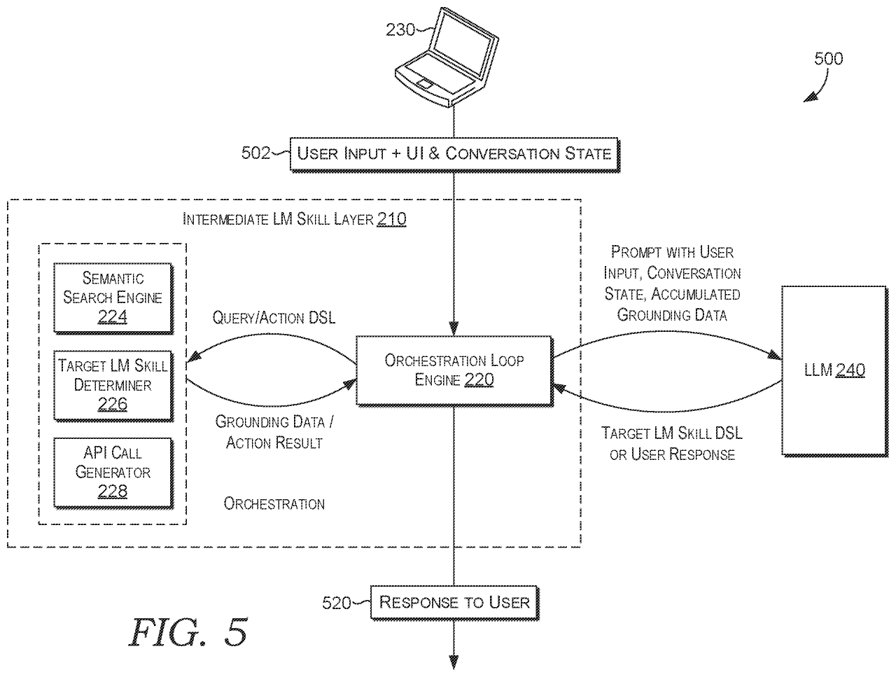

Turning to FIG. 5, depicted is a flow diagram 500 of an orchestration loop engine 220 implemented by an intermediate LM skill layer 210 in communication with a user device 230 and an LLM 240, in accordance with an embodiment of the present disclosure. In some embodiments, the components illustrated in FIG. 5 correspond to components in FIGS. 2, 3, and 4, and are configured to implement aspects of the flow diagrams of FIGS. 7, 8, and 9. As illustrated, the intermediate LM skill layer 210 receives a user input 502 while in a conversation state. In one example, “conversation state” refers to a model's ability to maintain context and understand the inputs over a period of time to allow the model to generate coherent and contextually relevant responses across multiple turns in a conversation. For example, the conversation state supports contextual understanding, context preservation, multi-turn conversation settings, and/or context resetting, to name a few.

Continuing with FIG. 5, based on the received user input, the orchestration loop engine 220 submits communications (illustrated as “query/action DSL” in FIG. 5) to the semantic search engine 224, the target LM skill determiner 226, and/or the API call generator 228 to cause these components to perform their respective functionalities, such as those discussed herein, for each task. In one embodiment, the communications are sent as Domain-Specific Language (DSL) commands. In response, the target LM skill determiner 226, and/or the API call generator 228 generates responses (illustrated as “grounding data/action result” in FIG. 5) that are received by the orchestration loop engine 220.

Embodiments of the orchestration loop engine 220 further send communications (illustrated as “prompt with user input, conversation state, accumulated ground data” in FIG. 5) to the LLM 240. In response, the LLM 240 generates and communicates a response (labeled as “target LLM skill DSL or user response” in FIG. 5) to the orchestration loop engine 220. For example, the orchestration loop engine 220 generates and sends a first command prompting the LLM 240 to describe a task based on the initial prompt, the user input, the contextual information from the context database 312 (FIG. 3), and/or an intent inferred from the contextual information. As another example, the orchestration loop engine 220 generates and sends a second command prompting the LLM 240 to select at least one LM skill of the plurality of candidate LM skills the target LM skill used to service an aspect of the initial prompt. In this example, the LLM 240 sends, to the orchestration loop, the target LM skill and corresponding API input parameters associated with the user input and the corresponding contextual information. In one embodiment, executing the orchestration loop comprises communicating, for each LM skill of the plurality of candidate LM skills, at least one command (for example, the second command) in domain-specific language (DSL) to cause the LLM 240 to generate a respective output. At least one target LM skill of the plurality of candidate LM skills is selected based on a level of relatedness determined based on a proximity in semantic vector space between the respective output and the input.

In some embodiments, after the orchestration loop is run for each task, a response 520 from the LLM 240 is directly communicated from the LLM 240 to the user device. Embodiments of the orchestration loop comprise computations for prompting the LLM 240 to select the at least one target LM skill based on the at least one task associated with the input. In the example above, three tasks were identified. After the at least one target LM skill is determined for each of these three tasks, the LLM 240 communicates API parameter inputs as an API call associated with an API of the at least one target LM skill. The response to the API call can be summarized, structured for user presentation, and communicated to the user, as illustrated by “response to user 520”.

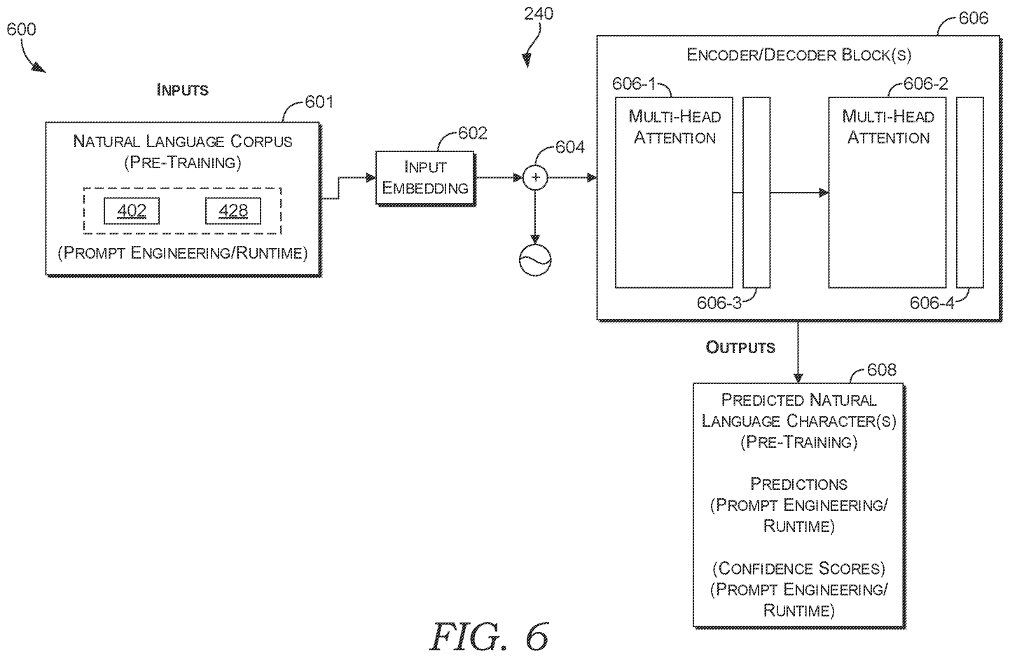

FIG. 6 is a block diagram of a language model 600 (for example, a BERT model or Generative Pre-Trained Transformer (GPT)-4 model) that uses particular inputs to make particular predictions (for example, answers to questions), according to some embodiments. In one embodiment, the language model 600 corresponds to the LLM 240 described herein. For example, this model 600 represents or includes the functionality as described with respect to the LLM 240 or the intermediate LM skill layer 210 of FIGS. 2, 3, 4, and 5. In various embodiments, the language model 600 includes one or more encoders and/or decoder blocks 606 (or any transformer or portion thereof).

First, a natural language corpus (for example, various WIKIPEDIA English words or BooksCorpus) of the inputs 601 are converted into tokens and then feature vectors and embedded into an input embedding 602 to derive meaning of individual natural language words (for example, English semantics) during pre-training. In some embodiments, to understand English language, corpus documents, such as text books, periodicals, blogs, social media feeds, and the like are ingested by the language model 600.

In some embodiments, each word or character in the input(s) 601 is mapped into the input embedding 602 in parallel or at the same time, unlike existing long short-term memory (LSTM) models, for example. The input embedding 602 maps a word to a feature vector representing the word. But the same word (for example, “apple”) in different sentences may have different meanings (for example, phone versus fruit). This is why a positional encoder 604 can be implemented. A positional encoder 604 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / 1000 {0}^{2 i / {d}_{model}} ) \qquad ( 1 )$$

$${PE}_{( pos , 2 i + 1 )} = cos ( pos / {10000}^{2 i / {d}_{model}} ) . \qquad ( 2 )$$

After passing the input(s) 601 through the input embedding 602 and applying the positional encoder 604, the output is a word embedding feature vector, which encodes positional information or context based on the positional encoder 604. These word embedding feature vectors are then passed to the encoder and/or decoder block(s) 606, where it goes through a multi-head attention layer 606-1 and a feedforward layer 606-2. The multi-head attention layer 606-1 is generally responsible for focusing or processing certain parts of the feature vectors representing specific portions of the input(s) 601 by generating attention vectors. For example, in Question-Answering systems, the multi-head attention layer 606-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = soft max ( \frac{Q \cdot {K}^{T}}{\sqrt{Dimension of vector Q , K or V}} ) \cdot V . \qquad ( 3 )$$

For multi-headed attention, there are multiple weight matrices W^{q}, W^{k} and W^{v}. so there are multiple attention vectors Z for every word. However, a neural network may expect one attention vector per word. Accordingly, another weighted matrix, W^{z}, is used to make sure the output is still an attention vector per word. In some embodiments, after the layers 606-1 and 606-2, there is some form of normalization (for example, batch normalization and/or layer normalization) performed to smoothen out the loss surface making it easier to optimize while using larger learning rates.

Layers 606-3 and 606-4 represent residual connection and/or normalization layers where normalization re-centers and rescales or normalizes the data across the feature dimensions. The feedforward layer 606-2 is a feed-forward neural network that is applied to every one of the attention vectors outputted by the multi-head attention layer 606-1. The feedforward layer 606-2 transforms the attention vectors into a form that can be processed by the next encoder block or make a prediction at 608. For example, given that a document includes first natural language sequence “the due date is . . . ,” the encoder/decoder block(s) 606 predicts that the next natural language sequence will be a specific date or particular words based on past documents that include language identical or similar to the first natural language sequence.

In some embodiments, the encoder/decoder block(s) 606 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 606 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 601 may be various historical documents, such as text books, journals, and periodicals, in order to output the predicted natural language characters in 608 (not make the predictions at runtime or prompt engineering at this point). The example encoder/decoder block(s) 606 takes in a sentence, paragraph, or sequence (for example, included in the input[s]601), with random words being replaced with masks. The goal is to output the value or meaning of the masked tokens. For example, if a line reads, “please [MASK] this document promptly,” the prediction for the “mask” value is “send.” This helps the encoder/decoder block(s) 606 understand the bidirectional context in a sentence, paragraph, or line at a document. In the case of NSP, the encoder/decoder block(s) 606 takes, as input, two or more elements, such as sentences, lines, or paragraphs, and determines, for example, if a second sentence in a document actually follows (for example, is directly below) a first sentence in the document. This helps the encoder/decoder block(s) 606 understand the context across all the elements of a document, not just within a single element. Using both of these together, the encoder/decoder block(s) 606 derives a good understanding of natural language.

In some embodiments, during pre-training, the input to the encoder/decoder block(s) 606 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 602). At the output side is the binary output for the next sentence prediction. For example, this component may output 1, for example, if masked sentence 2 followed (for example, was directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 602) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s]601) that is encoded into a vector (for example, first sentence, second sentence, and so forth, assuming a top-down and right-to-left approach). The position embeddings are vectors that represent the position of a particular word in such a sentence that can be produced by positional encoder 604. When these three embeddings are added or concatenated together, an embedding vector is generated that is used as input into the encoder/decoder block(s) 606. The segment and position embeddings are used for temporal ordering since all of the vectors are fed into the encoder/decoder block(s) 606 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 606 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 606 processing the inputs 402 and/or 428 (for example, the inputs 402 and/or 428 of FIG. 4) in order to make the predictions and generate a prompt response, as indicated in 604. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving a more human-like or best answers, while trying to minimize the worst answers (for example, via reinforcement learning). In some embodiments, a “prompt” as described herein includes one or more of: a request (for example, a question or instruction [for example, “write a poem” ]), target content, and one or more examples, as described herein.

In some embodiments, the inputs 601 additionally or alternatively include other inputs, such as the inputs to the LLM 240 described in FIGS. 2, 3, 4, and 5. In an illustrative example, in some embodiments, the predictions of the output 606 represent a description for a task or a selection of at least one target LM skill based on the tasks determined from the initial prompt and contextual information described herein. For instance, the predictions may be generative text, such as a generative answer to a question, machine translation text, or other generative text. Alternative to prompt engineering, certain embodiments of inputs 402 and/or 428 (or the inputs or prompts sent to or received by the LLM 240 described in FIGS. 2, 3, 4, and 5) represent inputs provided to the encoder/decoder block(s) 608 at runtime or after the model 600 has been trained, tested, and deployed. Likewise, in these embodiments, the predictions in the output 608 represent predictions made at runtime or after the model 600 has been trained, tested, and deployed.

Turning now to FIGS. 7, 8, and 9, aspects of example process flows 700, 800, and 900 are illustratively depicted for some embodiments of the disclosure. Embodiments of process flows 700, 800, and 900 each comprise a method (sometimes referred to herein as method 700, 800, and 900) carried out to implement various example embodiments described herein. For instance, at least one of process flow 700, 800, and 900 is performed to programmatically generate, for a target communication item, a contextual title, which is used to provide any of the improved electronic communications technology or enhanced user computing experiences described herein.

Each block or step of process flow 700, process flow 800, process flow 900, and other methods described herein comprises a computing process performed using any combination of hardware, firmware, and/or software. For instance, various functions are carried out by a processor executing instructions stored in memory, such as memory 1012 as described in FIG. 10. Embodiments of the methods can also be embodied as computer-usable instructions stored on computer storage media. Embodiments of the methods are provided by a standalone application, a service or hosted service (standalone or in combination with another hosted service), or a plug-in to another product, to name a few. For example, the blocks of process flow 700, 800, and 900 that correspond to actions (or steps) to be performed (as opposed to information to be processed or acted on) are carried out by one or more computer applications or services, in some embodiments, which operate on one or more user devices (such as user devices 102a and 102b through 102n of FIG. 1), and/or are distributed across multiple user devices, and/or servers, or by a distributed computing platform, and/or are implemented in the cloud, such as is described in connection with FIG. 11. In some embodiments, the functions performed by the blocks or steps of process flows 700, 800, and 900 are carried out by components of system 200, as described in FIG. 2.

With reference to FIG. 7, aspects of example process flow 700 are illustratively provided for transmitting an API call causing execution of the API call against the API of at least one target LM skill, in accordance with an embodiment of the present disclosure. As illustrated, at block 702, example process flow 700 includes receiving, from a user device, an input comprising an initial prompt indicative of at least one task. At block 704, example process flow 700 includes, based on the input, performing a semantic search to determine a plurality of candidate language model (LM) skills. At block 706, example process flow 700 includes, in response to performing the semantic search, receiving the plurality of candidate LM skills, each candidate LM skill comprising a corresponding Application Programming Interface (API) and a corresponding API description. At block 708, example process flow 700 includes selecting at least one target LM skill of the plurality of candidate LM skills based on an orchestration loop, the plurality of candidate LM skills, and the input, wherein the orchestration loop comprises operations for prompting a large language model (LLM) to select the at least one target LM skill based on the at least one task associated with the input. At block 712, example process flow 700 includes generating an API call associated with the at least one target LM skill and comprising an API parameter input into an API of the at least one target LM skill based on the input. At block 714, example process flow 700 includes transmitting the API call to cause execution of the API call against the API of the at least one target LM skill.

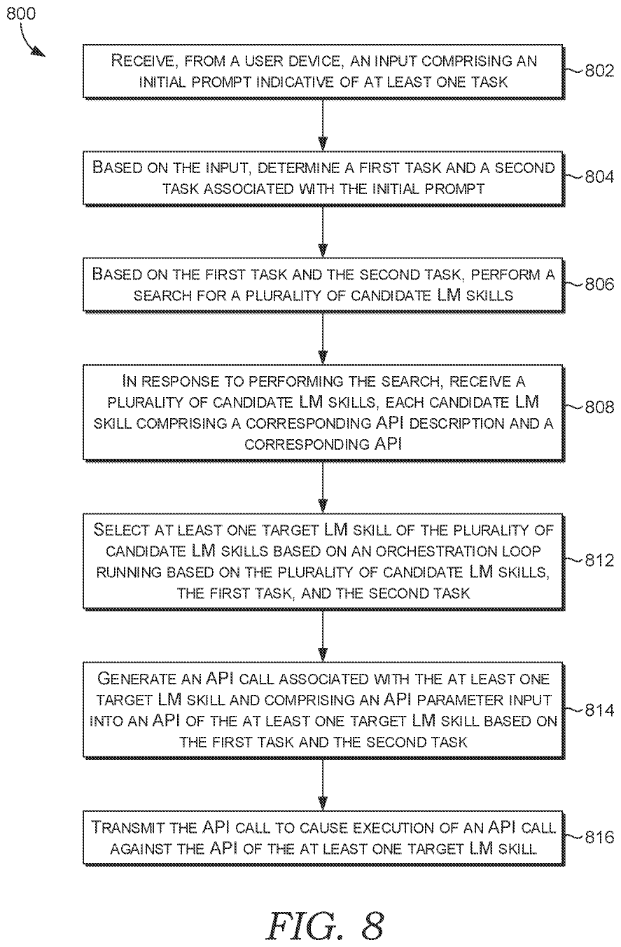

With reference to FIG. 8, aspects of example process flow 800 are illustratively provided for generating an API call associated with at least one target LM skill and comprising an API parameter input into an API of the at least one target LM skill based on a first task and a second task associated with an initial prompt, in accordance with an embodiment of the present disclosure. At block 802, example process flow 800 includes receiving, from a user device, an input comprising an initial prompt indicative of at least one task. At block 804, example process flow 800 includes determining, based on the input, a first task and a second task associated with the initial prompt. At block 806, example process flow 800 includes, based on the first task and the second task, performing a search for a plurality of candidate LM skills. At block 808, in response to performing the search, process flow 800 includes receiving a plurality of candidate LM skills, such that each candidate LM skill includes a corresponding API description and a corresponding API. At block 812, example process flow 800 includes selecting at least one target LM skill of the plurality of candidate LM skills based on an orchestration loop running based on the plurality of candidate LM skills, the first task, and the second task. At block 814, example process flow 800 includes generating an API call associated with the at least one target LM skill and comprising an API parameter input into an API of the at least one target LM skill based on the first task and the second task. At block 816, example process flow 800 includes transmitting the API call to cause execution of an API call against the API of the at least one target LM skill.

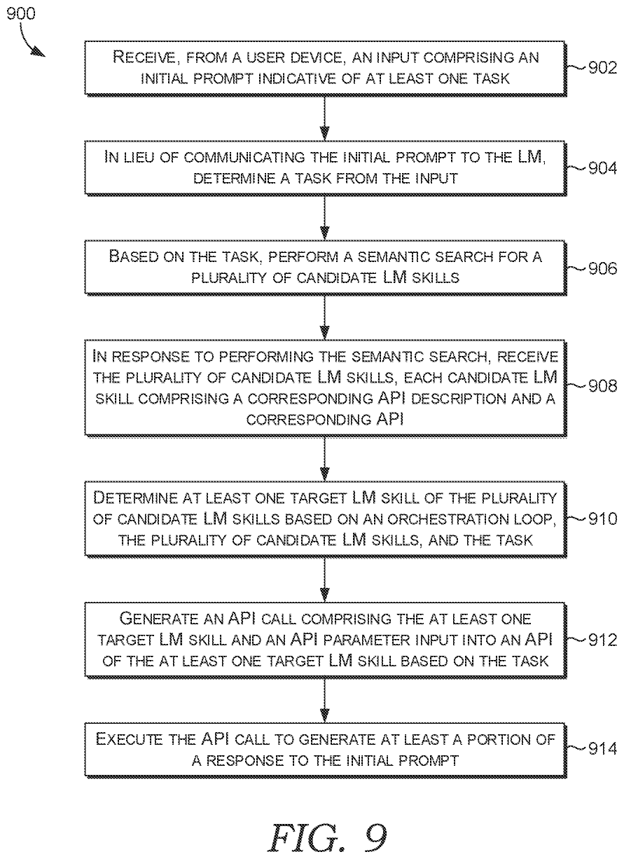

With reference to FIG. 9, aspects of example process flow 900 are illustratively provided for executing an API call to generate at least a portion of a response to an initial prompt, in accordance with an embodiment of the present disclosure. At block 902, example process flow 900 includes receiving, from a user device, an input comprising an initial prompt indicative of at least one task. At block 904, example process flow 900 includes, in lieu of communicating the initial prompt to the LM, determining a task from the input. At block 906, example process flow 900 includes performing, based on the task, a semantic search for a plurality of candidate LM skills. At block 908, example process flow 900 includes, in response to performing the semantic search, receiving the plurality of candidate LM skills, each comprising a corresponding API description and a corresponding API. At block 910, example process flow 900 includes determining at least one target LM skill of the plurality of candidate LM skills based on an orchestration loop, the plurality of candidate LM skills, and the task. At block 912, example process flow 900 includes generating an API call comprising the at least one target LM skill and an API parameter input into an API of the at least one target LM skill based on the task. At block 914, example process flow 900 includes executing the API call to generate at least a portion of a response to the initial prompt.

### OTHER EMBODIMENTS

In some embodiments, a system, such as the computerized system described in any of the embodiments above, comprises at least one computer processor and computer storage media storing computer-useable instructions that, when used by the at least one computer processor, cause the system to perform operations. The operations comprise receiving, from a user device, an input comprising an initial prompt indicative of at least one task; based on the input, performing a semantic search to determine a plurality of candidate language model (LM) skills; in response to performing the semantic search, receiving the plurality of candidate LM skills, each candidate LM skill comprising a corresponding Application Programming Interface (API) and a corresponding API description; selecting at least one target LM skill of the plurality of candidate LM skills based on an orchestration loop, the plurality of candidate LM skills, and the input, wherein the orchestration loop comprises operations for prompting a large language model (LLM) to select the at least one target LM skill based on the at least one task associated with the input; generating an API call associated with the at least one target LM skill and comprising an API parameter input into an API of the at least one target LM skill based on the input; and transmitting the API call, wherein transmitting the API call causes execution of the API call against the API of the at least one target LM skill.

In any combination of the above embodiments of the system, the orchestration loop is run until at least one of: a threshold quantity of loops is reached or until the at least one target LM skill has a threshold level of relatedness to the input.

In any combination of the above embodiments of the system, executing the orchestration loop comprises communicating, for each LM skill of the plurality of candidate LM skills, at least one command in domain-specific language (DSL) to generate a respective output, wherein the at least one target LM skill of the plurality of candidate LM skills is selected based on a level of relatedness determined based on a proximity in semantic vector space between the respective output and the input.

In any combination of the above embodiments of the system, performing the semantic search comprises at least one of: extracting, from the initial prompt, an intent; determining, from the intent, a task; transmitting an indication of the task to the LLM as a first command; or receiving a first LM response to the first command. The semantic search is performed against an external database using the first LM response, wherein the updated prompt is transmitted as a second command to the LLM. The second command is communicated after the first command.

In any combination of the above embodiments of the system, the operations further comprise receiving an API response to the API call; and transmitting the API response to the LLM without directly communicating the initial prompt to the LLM.

In any combination of the above embodiments of the system, the initial prompt from the user device is not communicated to the LLM.

In any combination of the above embodiments of the system, generating the API call comprises applying a portion of the input as the API parameter input that is applied into the API of the at least one target LM skill based on the input.

In any combination of the above embodiments of the system, the initial prompt is indicative of a user request to a large language model (LLM). The input comprises contextual information associated with at least one of the initial prompt, the user request, the user device, or a user profile associated with a user.

In any combination of the above embodiments of the system, performing the semantic search comprises determining, in semantic vector space, skills that are near the at least one task, wherein the plurality of candidate LM skills are semantically similar to and near in the vector space to the at least one task.

Various embodiments are directed to computer-implemented method comprising the following operations: receiving, from a user device, an input comprising an initial prompt indicative of at least one task; based on the input, determining a first task and a second task associated with the initial prompt; based on the first task and the second task, performing a search for a plurality of candidate LM skills; in response to performing the search receiving a plurality of candidate LM skills, each candidate LM skill comprising a corresponding API description and a corresponding API; selecting at least one target LM skill of the plurality of candidate LM skills based on an orchestration loop running based on the plurality of candidate LM skills, the first task, and the second task; generating an API call associated with the at least one target LM skill and comprising an API parameter input into an API of the at least one target LM skill based on the first task and the second task; and transmitting the API call to cause execution of an API call against the API of the at least one target LM skill.

In any combination of the above embodiments of the computer-implemented method, the orchestration loop comprises operations for prompting a large language model (LLM) to select the at least one target LM skill based on the at least one task associated with the input.

In any combination of the above embodiments of the computer-implemented method, the orchestration loop is run until at least one of: a threshold quantity of loops is reached or until the at least one target LM skill has a threshold level of relatedness to the input.

In any combination of the above embodiments of the computer-implemented method, determining the first task and the second task comprises: determining an intent based on contextual information associated with at least one of the initial prompt, a user request, the user device, or a user profile associated with a user; and generating a first command indicative of a first prompt executed against an LLM to determine at least one task based on the intent, wherein the first task and the second task are determined based on the first command.

In any combination of the above embodiments of the computer-implemented method, selecting the at least one target LM skill comprises generating a second command indicative of a second prompt executed against an LLM to determine the at least one target LM skill from the plurality of candidate LM skills.

In any combination of the above embodiments of the computer-implemented method, the initial prompt comprises a user request to an LLM, wherein the input further comprises contextual information associated with at least one of the initial prompt, the user request, the user device, or a user profile associated with a user.

Various embodiments are directed to one or more computer storage media having computer-executable instructions embodied thereon that, when executed, by one or more processors, cause the one or more processors to perform operations. The operations include receiving, from a user device, an input comprising an initial prompt indicative of at least one task. The operations include, in lieu of communicating the initial prompt to the LM: (a) determining a task from the input; (b) based on the task, performing a semantic search for a plurality of candidate LM skills; (c) in response to performing the semantic search, receiving the plurality of candidate LM skills, each candidate LM skill comprising a corresponding API description and a corresponding API; (d) determining at least one target LM skill of the plurality of candidate LM skills based on an orchestration loop, the plurality of candidate LM skills, and the task; and (e) generating an API call comprising the at least one target LM skill and an API parameter input into an API of the at least one target LM skill based on the task. The operations include executing the API call to generate at least a portion of a response to the initial prompt.

In any combination of the above embodiments of the one or more computer storage media, the operations further comprise determining a second task from the input, wherein at least (b), (c), (d), and (e) are further performed based on the second task.

In any combination of the above embodiments of the one or more computer storage media, the orchestration loop comprises computations for prompting a large language model (LLM) to select the at least one target LM skill based on the at least one task associated with the input.

In any combination of the above embodiments of the one or more computer storage media, the orchestration loop is run until at least one of: a threshold quantity of loops is reached or until the at least one target LM skill has a threshold level of relatedness to the input.

In any combination of the above embodiments of the one or more computer storage media, the initial prompt comprises a user request to a large language model (LLM), wherein the input further comprises contextual information associated with at least one of the initial prompt, the user request, the user device, or a user profile associated with a user.

### Example Computing Environments

Having described various implementations, several example computing environments suitable for implementing embodiments of the disclosure are now described, including an example computing device and an example distributed computing environment in FIGS. 10 and 11, respectively. With reference to FIG. 10, an example computing device is provided and referred to generally as computing device 1000. The computing device 1000 is but one example of a suitable computing environment and is not intended to suggest any limitation as to the scope of use or functionality of embodiments of the disclosure, and nor should the computing device 1000 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure are practiced in a variety of system configurations, including mobile devices, consumer electronics, general-purpose computers, more specialty computing devices, or the like. Embodiments of the disclosure are also practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher level software. Accordingly, in some embodiments, computer-executable instructions include any software, including low-level software written in machine code, higher level software such as application software, and any combination thereof. In this regard, the system components can manage resources and provide services for system functionality. Any other variations and combinations thereof are contemplated within the embodiments of the present disclosure.

With reference to FIG. 10, computing device 1000 includes a bus 1010 that directly or indirectly couples the following devices: memory 1012, one or more processors 1014, one or more presentation components 1016, one or more input/output (I/O) ports 1018, one or more I/O components 1020, and an illustrative power supply 1022. In one example, bus 1010 represents one or more buses (such as an address bus, data bus, or combination thereof). Although the various blocks of FIG. 10 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 10 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 10 and with reference to “computing device.”

Computing device 1000 typically includes a variety of computer-readable media. Computer-readable media can be any available media that can be accessed by computing device 1000 and includes both volatile and non-volatile, removable and non-removable media. By way of example, and not limitation, computer-readable media comprises computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 1000. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1012 includes computer storage media in the form of volatile and/or non-volatile memory. In one example, the memory is removable, non-removable, or a combination thereof. Hardware devices include, for example, solid-state memory, hard drives, and optical-disc drives. Computing device 1000 includes one or more processors 1014 that read data from various entities such as memory 1012 or I/O components 1020. As used herein and in one example, the term processor or “a processer” refers to more than one computer processor. For example, the term processor (or “a processor”) refers to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, cloud computing system, or parallel processing by more than a single processor. Further, various operations described herein as being executed or performed by a processor are performed by more than one processor.

Presentation component(s) 1016 presents data indications to a user or other device. Presentation components include, for example, a display device, speaker, printing component, vibrating component, and the like.

The I/O ports 1018 allow computing device 1000 to be logically coupled to other devices, including I/O components 1020, some of which are built-in. Illustrative components include a microphone, joystick, game pad, satellite dish, scanner, printer, or a wireless device. The I/O components 1020 can provide a natural user interface (NUI) that processes air gestures, voice, or other physiological inputs generated by a user. In some instances, inputs are transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1000. In one example, the computing device 1000 is equipped with depth cameras, such as stereoscopic camera systems, infrared camera systems, red-green-blue (RGB) camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

Some embodiments of computing device 1000 include one or more radio(s) 1024 (or similar wireless communication components). The radio transmits and receives radio or wireless communications. Example computing device 1000 is a wireless terminal adapted to receive communications and media over various wireless networks. Computing device 1000 may communicate via wireless protocols, such as code-division multiple access (“CDMA”), Global System for Mobile (“GSM”) communication, or time-division multiple access (“TDMA”), as well as others, to communicate with other devices. In one embodiment, the radio communication is a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a wireless local area network (WLAN) connection using the 802.11 protocol; a Bluetooth connection to another computing device is a second example of a short-range connection, or a near-field communication connection. A long-range connection may include a connection using, by way of example and not limitation, one or more of Code-Division Multiple Access (CDMA), General Packet Radio Service (GPRS), Global System for Mobile Communication (GSM), Time-Division Multiple Access (TDMA), and 802.16 protocols.

Referring now to FIG. 11, an example distributed computing environment 1100 is illustratively provided, in which implementations of the present disclosure can be employed. In particular, FIG. 11 shows a high-level architecture of an example cloud computing platform 1110 that can host a technical solution environment or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 1100 that includes cloud computing platform 1110, rack 1120, and node 1130 (for example, computing devices, processing units, or blades) in rack 1120. The technical solution environment can be implemented with cloud computing platform 1110, which runs cloud services across different data centers and geographic regions. Cloud computing platform 1110 can implement the fabric controller 1140 component for provisioning and managing resource allocation, deployment, upgrade, and management of cloud services. Typically, cloud computing platform 1110 acts to store data or run service applications in a distributed manner. Cloud computing platform 1110 in a data center can be configured to host and support operation of endpoints of a particular service application. In one example, the cloud computing platform 1110 is a public cloud, a private cloud, or a dedicated cloud.

Node 1130 can be provisioned with host 1150 (for example, operating system or runtime environment) running a defined software stack on node 1130. Node 1130 can also be configured to perform specialized functionality (for example, computer nodes or storage nodes) within cloud computing platform 1110. Node 1130 is allocated to run one or more portions of a service application of a tenant. A tenant can refer to a customer utilizing resources of cloud computing platform 1110. Service application components of cloud computing platform 1110 that support a particular tenant can be referred to as a multi-tenant infrastructure or tenancy. The terms “service application,” “application,” or “service” are used interchangeably with regards to FIG. 11, and broadly refer to any software, or portions of software, that run on top of, or access storage and computing device locations within, a datacenter.

When more than one separate service application is being supported by nodes 1130, certain nodes 1130 are partitioned into virtual machines (for example, virtual machine 1152 and virtual machine 1154). Physical machines can also concurrently run separate service applications. The virtual machines or physical machines can be configured as individualized computing environments that are supported by resources 1160 (for example, hardware resources and software resources) in cloud computing platform 1110. It is contemplated that resources can be configured for specific service applications. Further, each service application may be divided into functional portions such that each functional portion is able to run on a separate virtual machine. In cloud computing platform 1110, multiple servers may be used to run service applications and perform data storage operations in a cluster. In one embodiment, the servers perform data operations independently but exposed as a single device, referred to as a cluster. Each server in the cluster can be implemented as a node.

In some embodiments, client device 1180 is linked to a service application in cloud computing platform 1110. Client device 1180 may be any type of computing device, such as user device 102 or 230 described with reference to FIGS. 1 and 2, respectively, and the client device 1180 can be configured to issue commands to cloud computing platform 1110. In embodiments, client device 1180 communicates with service applications through a virtual Internet Protocol (IP) and load balancer or other means that direct communication requests to designated endpoints in cloud computing platform 1110. Certain components of cloud computing platform 1110 communicate with each other over a network (not shown), which includes, without limitation, one or more local area networks (LANs) and/or wide area networks (WANs).

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “set” may be employed to refer to an ordered (i.e., sequential) or an unordered (i.e., non-sequential) collection of objects (or elements), such as machines (for example, computer devices), physical and/or logical addresses, graph nodes, graph edges, functionalities, and the like. As used herein, a set may include N elements, where Nis any positive integer. That is, a set may include 1, 2, 3, . . . N objects and/or elements, where N is a positive integer with no upper bound. Therefore, as used herein, a set does not include a null set (i.e., an empty set), that includes no elements (for example, N=0 for the null set). A set may include only a single element. In other embodiments, a set may include a number of elements that is significantly greater than one, two, three, or billions of elements. A set may be an infinite set or a finite set. The objects included in some sets may be discrete objects (for example, the set of natural numbers N). The objects included in other sets may be continuous objects (for example, the set of real numbers R). In some embodiments, “a set of objects” that is not a null set of the objects may be interchangeably referred to as either “one or more objects” or “at least one object,” where the term “object” may stand for any object or element that may be included in a set. Accordingly, the phrases “one or more objects” and “at least one object” may be employed interchangeably to refer to a set of objects that is not the null or empty set of objects. A set of objects that includes at least two of the objects may be referred to as “a plurality of objects.”

As used herein and in one example, the term “subset,” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjointed sets if the intersection between the two sets is the null set.

As used herein, the terms “application” or “app” may be employed interchangeably to refer to any software-based program, package, or product that is executable via one or more (physical or virtual) computing machines or devices. An application may be any set of software products that, when executed, provide an end user one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

For purposes of a detailed discussion above, embodiments of the present invention are described with reference to a computing device or a distributed computing environment; however, the computing device and distributed computing environment depicted herein are non-limiting examples. Moreover, the terms computer system and computing system may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A system comprising:
at least one computer processor; and
computer storage media storing computer-useable instructions that, when used by the at least one computer processor, cause the system to perform operations comprising:
receiving, from a user device, an input comprising an initial prompt indicative of at least one task;
based on the input, performing a semantic search to determine a plurality of candidate language model (LM) skills;
in response to performing the semantic search, receiving the plurality of candidate LM skills, each candidate LM skill comprising a corresponding Application Programming Interface (API) and a corresponding API description;
selecting at least one target LM skill of the plurality of candidate LM skills based on an orchestration loop, the plurality of candidate LM skills, and the input, wherein the orchestration loop comprises operations for prompting a large language model (LLM) to select the at least one target LM skill based on the at least one task associated with the input;
generating an API call associated with the at least one target LM skill and comprising an API parameter input into an API of the at least one target LM skill based on the input; and
transmitting the API call, wherein transmitting the API call causes execution of the API call against the API of the at least one target LM skill.

2. The system of claim 1, wherein the orchestration loop is run until at least one of: a threshold quantity of loops is reached or until the at least one target LM skill has a threshold level of relatedness to the input.

3. The system of claim 1, wherein executing the orchestration loop comprises communicating, for each LM skill of the plurality of candidate LM skills, at least one command in domain-specific language (DSL) to generate a respective output, wherein the at least one target LM skill of the plurality of candidate LM skills is selected based on a level of relatedness determined based on a proximity in semantic vector space between the respective output and the input.

4. The system of claim 1, wherein performing the semantic search comprises:
extracting, from the initial prompt, an intent;
determining, from the intent, a task;
transmitting an indication of the task to the LLM as a first command; and
receiving a first LM response to the first command, wherein the semantic search is performed against an external database using the first LM response, wherein the updated prompt is transmitted as a second command to the LLM, wherein the second command is communicated after the first command.

5. The system of claim 1, wherein the operations comprise:
receiving an API response to the API call; and
transmitting the API response to the LLM without directly communicating the initial prompt to the LLM.

6. The system of claim 1, wherein the initial prompt from the user device is not communicated to the LLM.

7. The system of claim 1, wherein generating the API call comprises applying a portion of the input as the API parameter input that is applied into the API of the at least one target LM skill based on the input.

8. The system of claim 1, wherein the initial prompt is indicative of a user request to a large language model (LLM), and wherein the input comprises contextual information associated with at least one of the initial prompt, the user request, the user device, or a user profile associated with a user.

9. The system of claim 1, wherein performing the semantic search comprises determining, in semantic vector space, skills that are near the at least one task, wherein the plurality of candidate LM skills are semantically similar to and near in the vector space to the at least one task.

10. A computer-implemented method comprising:
receiving, from a user device, an initial prompt indicative of at least one task;
based on the initial prompt, determining a first task and a second task associated with the initial prompt;
based on the first task and the second task, performing a search for a plurality of candidate LM skills;
in response to performing the search, receiving a plurality of candidate LM skills, each candidate LM skill comprising a corresponding API description and a corresponding API;
selecting at least one target LM skill of the plurality of candidate LM skills based on an orchestration loop running based on the plurality of candidate LM skills, the first task, and the second task;
generating an API call associated with the at least one target LM skill and comprising an API parameter input into an API of the at least one target LM skill based on the first task and the second task; and
transmitting the API call to cause execution of an API call against the API of the at least one target LM skill.

11. The computer-implemented method of claim 10, wherein the orchestration loop comprises operations for prompting a large language model (LLM) to select the at least one target LM skill based on the at least one task associated with the initial prompt.

12. The computer-implemented method of claim 10, wherein the orchestration loop is run until at least one of: a threshold quantity of loops is reached or until the at least one target LM skill has a threshold level of relatedness to the initial prompt.

13. The computer-implemented method of claim 10, wherein determining the first task and the second task comprises:
determining an intent based on contextual information associated with at least one of the initial prompt, a user request, the user device, or a user profile associated with a user; and
generating a first command indicative of a first prompt executed against an LLM to determine at least one task based on the intent, wherein the first task and the second task are determined based on the first command.

14. The computer-implemented method of claim 10, wherein selecting the at least one target LM skill comprises generating a second command indicative of a second prompt executed against an LLM to determine the at least one target LM skill from the plurality of candidate LM skills.

15. The computer-implemented method of claim 10, wherein the initial prompt comprises a user request to an LLM, wherein the initial prompt further comprises contextual information associated with at least one of the initial prompt, the user request, the user device, or a user profile associated with a user.

16. One or more computer storage media having computer-executable instructions embodied thereon that, when executed, by one or more processors, cause the one or more processors to perform operations comprising:
receiving, from a user device, an input comprising an initial prompt indicative of at least one task;
in lieu of communicating the initial prompt to the LM:
(a) determining a task from the input;
(b) based on the task, performing a semantic search for a plurality of candidate LM skills;
(c) in response to performing the semantic search, receiving the plurality of candidate LM skills, each candidate LM skill comprising a corresponding API description and a corresponding API;
(d) determining at least one target LM skill of the plurality of candidate LM skills based on an orchestration loop, the plurality of candidate LM skills, and the task; and
(e) generating an API call comprising the at least one target LM skill and an API parameter input into an API of the at least one target LM skill based on the task; and
executing the API call to generate at least a portion of a response to the initial prompt.

17. The one or more computer storage media of claim 16, wherein the operations further comprise determining a second task from the input, wherein at least (b), (c), (d), and (e) are further performed based on the second task.

18. The one or more computer storage media of claim 16, wherein the orchestration loop comprises computations for prompting a large language model (LLM) to select the at least one target LM skill based on the at least one task associated with the input.

19. The one or more computer storage media of claim 16, wherein the orchestration loop is run until at least one of: a threshold quantity of loops is reached or until the at least one target LM skill has a threshold level of relatedness to the input.

20. The one or more computer storage media of claim 16, wherein the initial prompt comprises a user request to a large language model (LLM), wherein the input further comprises contextual information associated with at least one of the initial prompt, the user request, the user device, or a user profile associated with a user.
